(19) United States
(12) Patent Application Publication
(10) Pub. No.: US 2018/0345548 A1
(43) Pub. Date: Dec. 6, 2018

(54) MOLDING SYSTEM AND METHOD FOR MULTIPLE COMPONENTS

(71) Applicant: GM GLOBAL TECHNOLOGY OPERATIONS LLC, Detroit, MI (US)

(72) Inventors: Bunhom Ngem, Troy, MI (US); Kevin M. Vine, Macomb, MI (US)

(21) Appl. No.: 15/613,324

(22) Filed: Jun. 5, 2017

(51) Int. Cl. B29C 45/00; B29C 31/00

(52) U.S. Cl. CPC B29C 45/0062; B29C 45/16; B29C 31/008

(57) ABSTRACT

An apparatus includes a mold. The mold has a first mold part with a first interior surface and a second mold part with a second interior surface. The apparatus additionally includes a movable member disposed proximate the mold. The movable member is movable between a first position and a second position. In the first position the movable member cooperates with the first interior surface and second interior surface to define a first mold cavity, and in the second position the movable member cooperates with the first interior surface and second interior surface to define a second mold cavity. The second mold cavity has a shape distinct from the first mold cavity.

### TECHNICAL FIELD

The present disclosure relates to manufacturing components, and more particularly to injection-molding components for an automotive vehicle.

### INTRODUCTION

Injection molding refers to a manufacturing process for producing components via injection of a material into a mold. The material is heated to a fluid state, injected into the mold, and subsequently cooled and hardened within the mold to form the component. A variety of materials may be used, though plastic materials are particularly common.

### SUMMARY

An apparatus according to the present disclosure includes a mold. The mold has a first mold part with a first interior surface and a second mold part with a second interior surface. The apparatus additionally includes a movable member disposed proximate the mold. The movable member is movable between a first position and a second position. In the first position the movable member cooperates with the first interior surface and second interior surface to define a first mold cavity, and in the second position the movable member cooperates with the first interior surface and second interior surface to define a second mold cavity. The second mold cavity has a shape distinct from the first mold cavity.

In an exemplary embodiment, the apparatus additionally includes a biasing member arranged to bias the movable member toward the first position. Such embodiments may also include a blocking member arranged to selectively maintain the movable member in the first position.

In an exemplary embodiment, the first interior surface has an endwall and the movable member has a sidewall. In such embodiments, the first mold cavity has a first outermost periphery defined in part by the endwall and the second mold cavity has a second outermost periphery defined in part by the sidewall.

A method of manufacturing a component according to the present disclosure includes providing a mold having an interior surface, and providing a movable member proximate the interior surface. The movable member is movable between a first position and a second position. In the first position the movable member cooperates with the interior surface to define a first mold cavity shape, and in the second position the movable member cooperates with the interior surface to define a second mold cavity shape. The second mold cavity shape is distinct from the first mold cavity shape. The method additionally includes molding a first component with the movable member in the first position, and molding a second component with the movable member in the second position.

In an exemplary embodiment, the method additionally includes providing a biasing member arranged to bias the movable member toward the first position. Such embodiments may additionally include providing a blocking member arranged to selectively maintain the movable member in the first position, where molding a first component includes maintaining the movable member in the first position via the blocking member.

A mold assembly according to the present disclosure includes a first plate and a second plate. The first plate and second plate cooperatively define a first portion of a mold cavity. The assembly additionally includes an insert. The insert is movable between a first position and a second position. In the first position the insert cooperates with the first portion to define a first mold cavity shape, and in the second position the insert cooperates with the first portion to define a second mold cavity shape, which is distinct from the first mold cavity shape.

In an exemplary embodiment, the assembly additionally includes a biasing member arranged to bias the insert toward the first position. The biasing member may include a spring. Such embodiments may additionally include a blocking member arranged to selectively maintain the insert in the first position. In some such embodiments, the insert includes a flange, the blocking member has an engaged position and a disengaged position, and in the engaged position the blocking member engages the flange to inhibit motion of the insert from the first position to the second position.

In an exemplary embodiment, the first portion has an endwall and the insert has a sidewall, and wherein the first mold cavity shape has a first outermost periphery defined in part by the endwall and the second mold cavity shape has a second outermost periphery defined in part by the sidewall.

Embodiments according to the present disclosure provide a number of advantages. For example, the present disclosure provides a system and method for manufacturing multiple variations of a component using a single mold apparatus, thereby reducing time and resource requirements for manufacturing such components.

The above and other advantages and features of the present disclosure will be apparent from the following detailed description of the preferred embodiments when taken in connection with the accompanying drawings.

### BRIEF DESCRIPTION OF THE DRAWINGS

FIG. 1 illustrates an automotive grille including an injection-molded blocker element;

FIG. 2 is a first schematic view of a mold apparatus according to the present disclosure;

FIG. 3 is a second schematic view of a mold apparatus according to the present disclosure; and

FIG. 4 is a flowchart representation of a method according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desirable for particular applications or implementations.

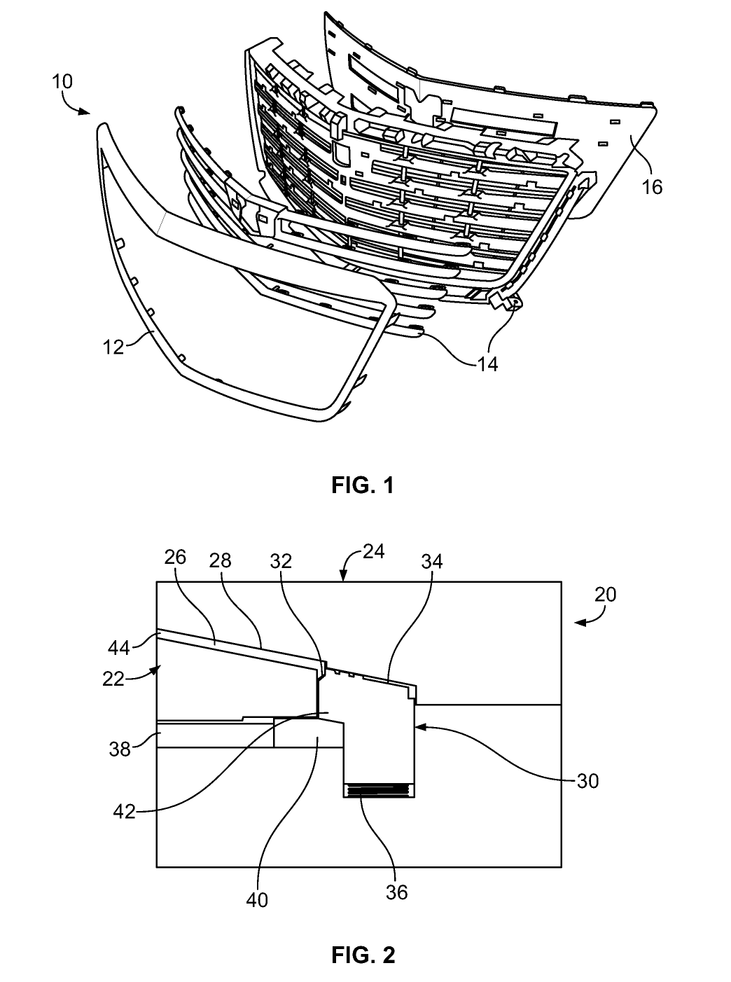

Referring now to FIG. 1, an exploded view of a grille assembly 10 for an automotive vehicle is shown. The grille assembly 10 is preferably arranged at a fore portion of the vehicle, such that air may flow from the outside of the vehicle through the grille assembly 10 into an engine compartment. The grille assembly 10 includes a bezel 12 arranged about at least one grille member 14. The grille member or members 14 include a plurality of elongate members defining a grid through which air may pass. In many vehicles, the grille member or members 14 are designed for primarily aesthetic purposes, and may not inherently provide optimal air flow into the engine compartment.

A blocker member 16 is provided aft of the grille member or members 14, i.e. fore of the engine compartment. The blocker member 16 is a generally flat panel having one or more apertures therethrough. The apertures are sized to permit a desired air flow rate into the engine compartment under typical operating conditions.

In some situations, it may be desirable to quickly and flexibly produce multiple variations of the blocker member 16. As an example, some automotive vehicles may be offered with multiple engine options, each having differing air flow requirements. As a result, different blocker members may be desirable to accompany the different engine options. As another example, design changes may be made late in a production cycle, necessitating a relatively rapid change in the size of the apertures or overall size of the blocker member 16.

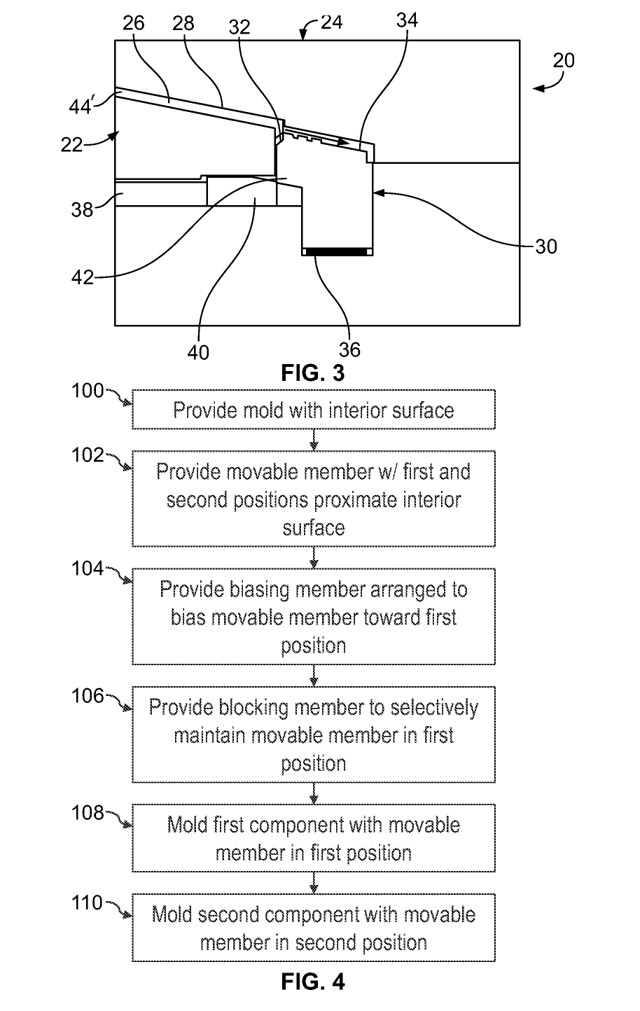

Referring now to FIGS. 2 and 3, a mold assembly 20 is shown schematically. The mold assembly 20 includes a first plate 22 and a second plate 24. The first plate 22 is provided with a first interior surface 26, and the second plate 24 is provided with a second interior surface 28.

A movable member 30 is provided proximate the first interior surface 26 and the second interior surface 28. The movable member 30 has a first portion 32, which may be a sidewall portion, and a second portion 34, which may be an endwall portion. In the embodiment of FIGS. 2 and 3, the movable member 30 is disposed in a cavity associated with the first plat

The movable member 30 is movable relative to the first plate 22 and second plate 24. The movable member 30 has a first position, as illustrated in FIG. 2, and a second position, as illustrated in FIG. 3. In the first position, a first mold cavity shape is defined by the first interior surface 26, second interior surface 28 and first potion 32 of the movable member 30. In the second position, a second mold cavity shape is defined by the first interior surface 26, second interior surface 28, and second portion 34 of the movable member 30. The second mold cavity shape is thereby different from the first mold cavity shape.

A biasing member 36 is provided proximate the movable member 30. The biasing member 36 applies a force on the movable member 30 to bias the movable member 30 toward the first position. In the embodiment of FIGS. 2 and 3 the biasing member is illustrated as a coil spring. However, in other embodiments, other biasing members may be used.

A pin 38 is provided proximate the movable member 30. The pin 38 serves as a blocking member to selectively retain the movable member 30 in the first position. The pin 38 is movable between an engaged position, illustrated in FIG. 2, and a disengaged position, illustrated in FIG. 3. In the engaged position, a head 40 of the pin 38 engages a flange 42 of the movable member 30 and thereby retains the movable member 30 in the first position. In the disengaged position, the head 40 is disengaged from the flange 42, thereby permitting the movable member 32 to move to the second position. In various embodiments, the pin 38 may be manually moved between the engaged and disengaged positions, driven by an actuator, or moved according to various other means.

As may be seen, the mold assembly 20 may thereby be used to create parts having two distinct shapes.

With the pin 38 in the engaged position as illustrated in FIG. 2, the movable member 30 is retained in the first position. Material 44 injected between the first surface 26 and second surface 28 may fill the first mold cavity shape defined by the first interior surface 26, second interior surface 28 and first potion 32 of the movable member 30. The material 44 may thereafter be cooled to create a component having a shape inverse to the first mold cavity shape.

With the pin 38 in the disengaged position as illustrated in FIG. 3, the movable member 30 is not retained in the first position. Material 44′ injected between the first surface 26 and second surface 28 may overcome the force exerted by the bias member 36 and thereby drive the movable member 30 to the second position. The material 44′ may then fill the second mold cavity shape defined by the first interior surface 26, second interior surface 28 and second potion 34 of the movable member 30, as illustrated by the arrow. The material 44′ may thereafter be cooled to create a component having a shape inverse to the second mold cavity shape.

The mold assembly 20 may therefore be used to mold first and second components having distinct shapes. The mold assembly 20 may be designed to mold first and second blockers for different engine options, as discussed above. The mold assembly 20 may also be designed to mold different sizes of blockers, thereby accommodating potential design changes. The mold assembly 20 may also be designed to mold variations of other types of components.

While only one movable member is illustrated in the embodiment of FIGS. 2 and 3, in other embodiments additional movable members may be provided, thereby providing additional flexibility in manufacturing additional components from a single mold assembly.

While the embodiment of FIGS. 2 and 3 include first and second mold plates, other embodiments may include other numbers or configurations of mold plates.

Referring now to FIG. 4, a method of manufacturing components according to the present disclosure is illustrated in flowchart form.

A mold is provided, as illustrated at block 100. The mold has an interior surface. The mold may include first and second plates having first and second interior surfaces cooperating to define the interior surface, as illustrated in the embodiment of FIGS. 2 and 3.

A movable member is provided proximate the interior surface, as illustrated at block 102. The movable member has first and second positions. In the first position the movable member cooperates with the interior surface to define a first mold cavity shape, and in the second position the movable member cooperates with the interior surface to define a second mold cavity shape. The second mold cavity shape is distinct from the first mold cavity shape.

A biasing member is provided, as illustrated at block 104. The biasing member is arranged to bias the movable member toward the first position.

A blocking member is provided, as illustrated at block 106. The blocking member is arranged to selectively maintain the movable member in the first position.

A first component is molded with the movable member in the first position, as illustrated at block 108. The first component thereby has a shape inverse to the first mold cavity shape.

A second component is molded with the movable member in the second position, as illustrated at block 110. The second component thereby has a shape inverse to the second mold cavity shape.

As may be seen, the present disclosure provides a system and method for flexibly manufacturing components having differing shapes, thereby enabling manufacture of multiple distinct components using a single mold assembly.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An apparatus comprising:
a mold having a first mold part with a first interior surface and a second mold part with a second interior surface;
a movable member disposed proximate the mold, the movable member being movable between a first position and a second position, wherein in the first position the movable member cooperates with the first interior surface and second interior surface to define a first mold cavity, and in the second position the movable member cooperates with the first interior surface and second interior surface to define a second mold cavity, the second mold cavity having a shape distinct from the first mold cavity.

2. The apparatus of claim 1, further comprising a biasing member arranged to bias the movable member toward the first position.

3. The apparatus of claim 2, further comprising a blocking member arranged to selectively maintain the movable member in the first position.

4. The apparatus of claim 1, wherein the first interior surface has an endwall and the movable member has a sidewall, and wherein the first mold cavity has a first outermost periphery defined in part by the endwall and the second mold cavity has a second outermost periphery defined in part by the sidewall.

5. A method of manufacturing a component comprising:
providing a mold having an interior surface;
providing a movable member proximate the interior surface, the movable member being movable between a first position and a second position, wherein in the first position the movable member cooperates with the interior surface to define a first mold cavity shape, and in the second position the movable member cooperates with the interior surface to define a second mold cavity shape, distinct from the first mold cavity shape;
molding a first component with the movable member in the first position; and
molding a second component with the movable member in the second position.

6. The method of claim 5, further comprising providing a biasing member arranged to bias the movable member toward the first position.

7. The method of claim 6, further comprising providing a blocking member arranged to selectively maintain the movable member in the first position, wherein molding a first component includes maintaining the movable member in the first position via the blocking member.

8. A mold assembly comprising:
a first plate and a second plate cooperatively defining a first portion of a mold cavity; and
an insert, the insert being movable between a first position and a second position, wherein in the first position the insert cooperates with the first portion to define a first mold cavity shape, and in the second position the insert cooperates with the first portion to define a second mold cavity shape, distinct from the first mold cavity shape.

9. The mold assembly of claim 8, further comprising a biasing member arranged to bias the insert toward the first position.

10. The mold assembly of claim 9, wherein the biasing member comprises a spring.

11. The mold assembly of claim 9, further comprising a blocking member arranged to selectively maintain the insert in the first position.

12. The mold assembly of claim 11, wherein the insert includes a flange, the blocking member has an engaged position and a disengaged position, and in the engaged position the blocking member engages the flange to inhibit motion of the insert from the first position to the second position.

13. The mold assembly of claim 8, wherein the first portion has an endwall and the insert has a sidewall, and wherein the first mold cavity shape has a first outermost periphery defined in part by the endwall and the second mold cavity shape has a second outermost periphery defined in part by the sidewall.
